(19) United States
(12) Patent Application Publication
(10) Pub. No.: US 2012/0124796 A1
(43) Pub. Date: May 24, 2012

(54) SYSTEM FOR PRODUCING COMPOSITE BEAMS AND FLOOR STRUCTURES OF BUILDINGS BY MEANS OF BENT SECTIONS MADE OF STEEL AND ANOTHER MATERIAL ATTACHED BY MEANS OF CONNECTORS FORMED IN THE SECTION MADE OF STEEL

(75) Inventor: Angel Ibañez Ceba, Salinas de Pamplona (Navarra) (ES)

(73) Assignee: IBAÑEZ LAZURTEGUI, S.L, Salinas de Pamplona (Navarra) (ES)

(21) Appl. No.: 13/388,778

(22) PCT Filed: Jul. 19, 2010
(86) PCT No.: PCT/ES2010/000313

§ 371 Date: Feb. 3, 2012

(30) Foreign Application Priority Data
Aug. 3, 2009 (ES) P200901712

(51) Int. Cl. B23P 21/00

(52) U.S. Cl. 29/33 K

(57) ABSTRACT

The present invention relates to a system for producing composite beams and floor structures of buildings by means of bent sections made of steel and another material attached by means of connectors formed in the section made of steel, made up of sections (1) made of steel obtained by means of bending or shaping steel sheet of little thickness and an upper slab or board (2) made of another material such as concrete, wood or resin fibreboard. The sections (1) made of steel are special shapes and incorporate in the sheet itself connectors (3) obtained by means of cutting, drawing and bending the sheet in certain areas of the metal section (1) which are attached to the slab or board (2) made of the other material. The metal sections (1) incorporate a groove (4) :in their design which allows the attachment to other metal beams (5) or metal supports (6) by means of special parts formed by flat bars (7, 8 and 9).

### FIELD OF THE ART

The present invention is comprised in the field of building composite structures made of steel and another material for application in structures of all types of buildings.

### STATE OF THE ART

The use of supports and of composite beams made of steel and concrete is a widely used process in the state of the art.

Rolled steel sections which are attached to is head of reinforced concrete through “connectors” which are welded or nailed to the metal section and which are embedded within the head of concrete for transmitting thereto the necessary stresses so that the section made of steel and the body of concrete work together and obtain a strength greater than that of each element separately are normally used for producing composite beams.

Composite beams connecting sections made of steel with wooden boards or parts or boards or parts made by means of fibres and, resins are less common. Despite that, the use of these materials for manufacturing composite beams as an alternative to concrete is also possible provided that the deformability of the materials is taken into account, i,e., the assembly is designed according to the elastic moduli of the materials used and with sufficient connections between one another assuring the transmission of stresses between both materials.

Rolled steel sections characterised in that they have areas with sufficient thickness in the various parts making up the section are normally used for producing composite beams. The I-shaped sections which are normally used are thus formed by two upper and lower flanges and a central core attaching them to one another. The upper flange is normally the portion of the section connected with the compression head of concrete or of another material, and connectors which are anchored in the upper flange of the section made of steel by means of welding, nailing or any other securing method are used to that end.

For the attachment between the connectors and the section to be efficient, it is necessary for the metal section which is used in the composite beam to have a thick enough flange so as to be able to support the attachment of the anchorage by means of welding or nailing.

This attachment is difficult when using open sections of little thickness obtained by means of bending flat sheets, since the connectors which are normally used cannot be attached to the section with the necessary strength given the little thickness of the sheet of the section.

In order to solve this difficulty, the following invention described below and which is intended to be applied in the construction of composite beams and joists of floor structures for all types of buildings is proposed.

### OBJECT OF THE INVENTION

The construction of composite beams or joists of floor structures of buildings, formed by sections made of steel obtained by means of bending or shaping flat steel sheets of little thickness and an upper slab or board made of another material such as concrete, wood or resin fibreboard, is proposed in the present invention. The sections made of steel have special shapes and have metal connectors incorporated in the sheet itself obtained by means of cutting, drawing and bending the sheet in certain areas of the section. These connectors have shapes which allow connecting the metal section with the other material, and these shapes depend on if this material is concrete, wood or resin fibreboards, to allow both materials to form a very strong assembly.

These sections made of steel have shapes intending to optimise the overall strength of the composite area, resulting in a very light assembly due to the lightness of both the metal section and of the upper board or slab made of the other material, which is possible because the contact surface between both materials has been reduced due to the presence of the connectors integrated in the section, such that most of the area of the section made of steel is away from the compression head thus increasing the moment of inertia of the composite section. The sections can have various bends and shapes for this purpose which will be detailed below in the description of the section.

When reinforced concrete is used, for the compressed head, which is the most common case, the metal sections are connected in the upper portion with a concrete slab of little thickness, making the assembly very light. The various shapes which are proposed for the connectors integrated in the metal section in those areas which are in contact with the concrete correspond to the need of fitting these elements within the concrete mass so that they are anchored therein and withstand the stresses to which they are subjected. These connectors integrated in the section are obtained by means of cutting, drawing and bending the sheet metal forming the section and are proposed as strips cut laterally, drawn and bent with the shape of a trapezium or as rectangular strips cut in three sides and bent with several bends and angles according to the manner of working the material,

The possibility of including ribs or bulkings in certain areas of the metal section, made in the sheet vertically and regularly distributed along the upper vertical sectors of the section, is proposed to improve the adherence and the combined work between the steel and the concrete.

When wooden parts or boards or fibreboards with resins are used for the compressed head, the connectors linking the metal section with these boards have shapes similar to those used in the concrete but they allow nailing on the wooden boards or fibreboards, they can even traverse the entire thickness, protruding from the other side for bending the protruding portion and thus being firmly attached to the board. The attachment between both materials can be complemented with adhesives or glues on the contacting surfaces of the section made of steel and the wooden board or fibreboard or of this board with other boards which can be attached thereto in the upper portion to increase the thickness of the board.

The possibility of establishing an assembly formed by two metal sections and one concrete slab, wooden hoard or fibreboard on the edges of which continuous sheet parts have been arranged along the edge of the board is proposed in both cases. These parts have a slanted projection in the central area for being attached to other slabs or boards which also have edge parts fitting with those of the previous one with a certain clearance for allowing placement and then rigidizing the attachment by means of a part having a rectangular section which is snap fitted between the two edge parts.

The possibility of replacing the wooden board or resin fibreboard with a C-shaped section made of steel sheet placed horizontally and with the edges of the flanges downwards, and where the section made of steel sheet has a downwards bend at the end of the horizontal sectors fitting with the flange of the C-shaped section is also proposed. The attachment of both sections to one another is performed, on each side of the C-shaped section, by means of a double row of connectors being able to be placed in the longitudinal direction of the sections or be turned 90° about the axis.

In order to transversally rigidize the on site attachment of several concrete slabs, wooden boards or fibreboards with resin with the corresponding metal sections, transversally placing two C-shaped sections in the lower portion, which are placed horizontally and with the edges of the flanges downwards such that one of these C-shaped sections follows a layout with slanted bars going from the lower portion of the metal sections to the intermediate lower area of the slabs or boards, being attached thereto by means of screws or nails, is also proposed. The other C-shaped section follows a horizontal layout and at its lower portion is fitted with and attached by means of screws or nails to the previous C-shaped section at the meeting points with the lower portion of the metal sections.

Two main advantages are obtained with respect to the previous state of the art, which firstly consist of being able to use metal sections of little thickness for producing composite beams and joists of a floor structure in building structures since it is otherwise not possible to couple outside connectors to these metal sections due to the scarce thickness of the sheet, and secondly, because with this method the process of placing connectors is eliminated, lowering costs, since the connectors are included within the design of the section itself.

### DESCRIPTION OF THE DRAWINGS

FIG. 1 shows an exploded perspective view of the arrangement of the metal section made of sheet metal with its integrated connectors, the upper concrete slab and the support and attachment, parts for the support and attachment with other elements of the structure of a building (beams and pillars).

FIG. 2 shows an exploded perspective view of the distribution of the metal section made of sheet metal with its integrated connectors, the upper wooden board or resin fibreboard and the support and attachment parts for the support and attachment with other elements of the structure of a building (beams and pillars).

FIG. 3 shows a sectional view of the basic geometry of the section made of steel with an upper plane provided with connectors for attachment with the other material.

FIG. 4 shows a sectional view of a variant, of the basic geometry of the section made of steel incorporating a widening in the shape of an inverted bottle neck located in its upper portion for allowing the placement of an inner steel reinforcement the purpose of which is to increase the fire resistance of the assembly.

FIG. 5 shows an enlarged sectional view of a variant of the basic geometry of the section made of steel in its upper portion so that it has more planes with connectors for attachment with the other material,

FIG. 6 shows a sectional view of a variant of the basic geometry of the section made of steel in which the flanges of its lower portion have been bent upwards with a certain angle leaving side channels where installations can be housed while at the same time achieving an aesthetic effect in the beam when it is exposed.

FIG. 7 shows a perspective view of one of the types of connectors which can be used for connecting the section made of steel with concrete slabs, specifically a connector formed by trapezoidal strips of sheet.

FIG. 8 shows a perspective view of one of the connectors which can be used for connecting the section made of steel with concrete slabs, specifically a connector formed by rectangular strips of sheet bent in three sectors with certain angles.

FIG. 9 shows a perspective view of a variant of the previous connector in which double bent rectangular strips of sheet having the same shape as the previous one have been arranged.

FIG. 10 shows a perspective view of four variants of the two previous connectors, depending on the angles used for bending the sectors of the connector.

FIG. 11 shows a perspective view of a type of connector which can be used for connecting the section made of steel with wooden boards or resin fibreboards.

FIG. 12 shows a perspective view of the attachment parts for the attachment of the metal section with the metal supports or beams of the structural system attached by means of screws.

FIG. 13 shows a sectional view of a variant of the basic geometry of the section made of steel described in FIG. 4, including ribs or bulkings made in the sheet vertically and regularly distributed along upper vertical sectors of the section.

FIG. 14 shows a sectional view of an assembly formed by two metal sections and a concrete slab on the edges of which continuous sheet parts have been arranged along the edge of the board. These parts have a slanted projection in the central area for being attached to other slabs which also have edge parts which fit with those of the previous one with a certain clearance for allowing placement and then rigidizing the attachment by means of a part having a rectangular section which is snap fitted between the two edge; parts.

FIG. 15 shows a sectional view of an assembly where the wooden board or resin fibreboard is replaced with a C-shaped steel section placed horizontally and with the edges of the flanges downwards and where the section made of steel sheet has a downwards bend at the end of the horizontal sectors fitting with the flange of the C-shaped section. The attachment of both sections to one another is performed, on each side of the C-shaped section, by means of a double row of connectors, being able to be placed in the longitudinal direction of the sections or be turned 90° about the axis.

FIG. 16 shows a sectional view of an assembly formed by several concrete slabs, wooden boards or resin fibreboards with their corresponding metal sections which is transversally rigidized by means of two C-shaped sections placed horizontally and with the edges of the flanges downwards, such that one of these C-shaped sections follows a layout of slanted bars going from the lower portion of the metal sections to the intermediate lower area of the slabs or boards, being attached thereto by means of screws or nails. The other C-shaped section follows a horizontal layout and at its lower portion is fitted with and attached by means of screws or nails to the previous C-shaped section at the meeting points with the lower portion of the metal sections,

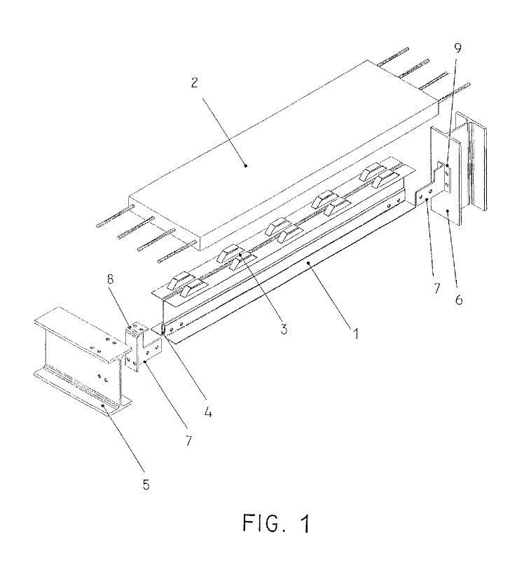

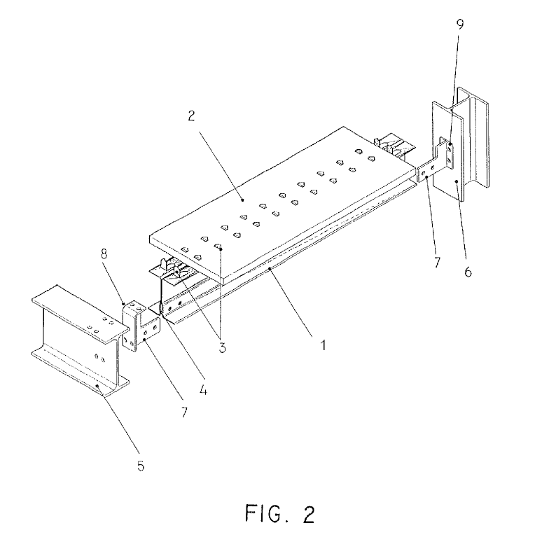

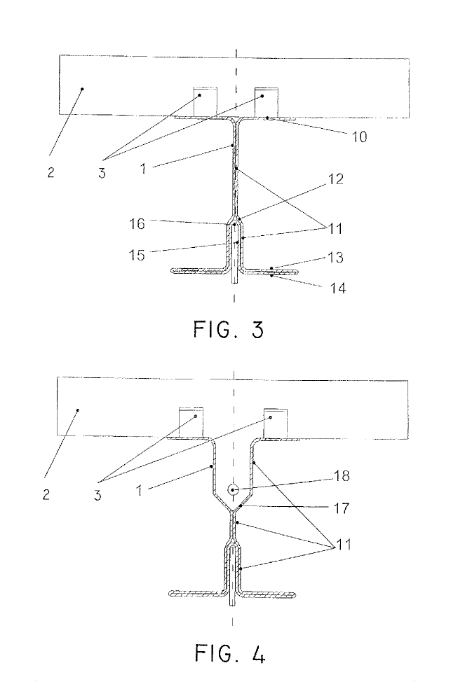

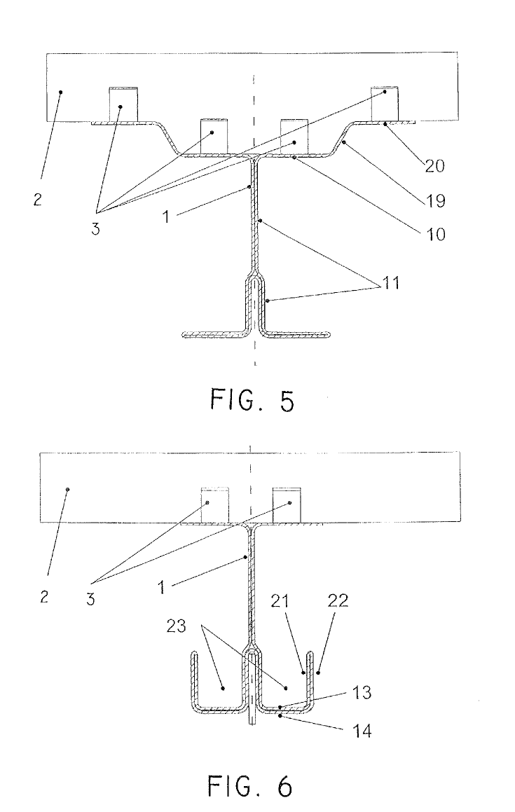

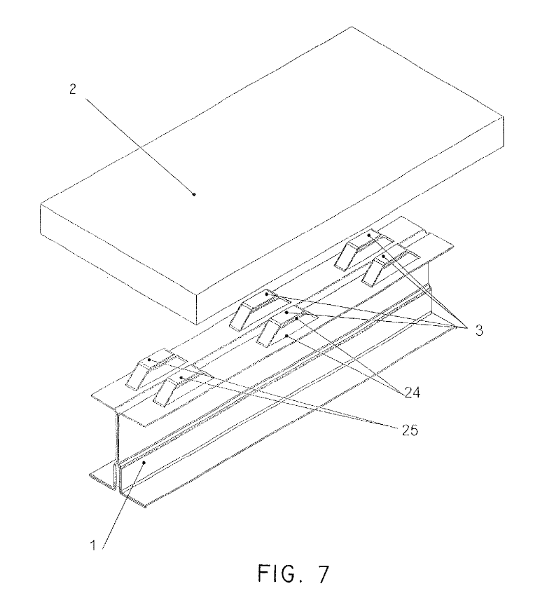

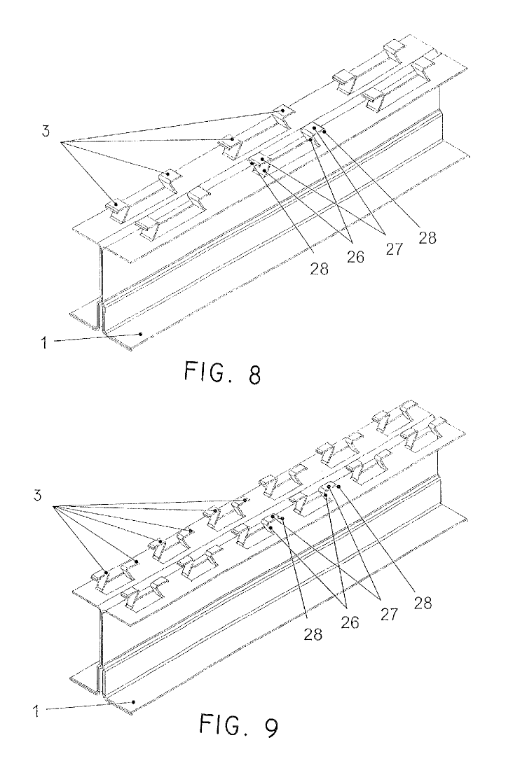

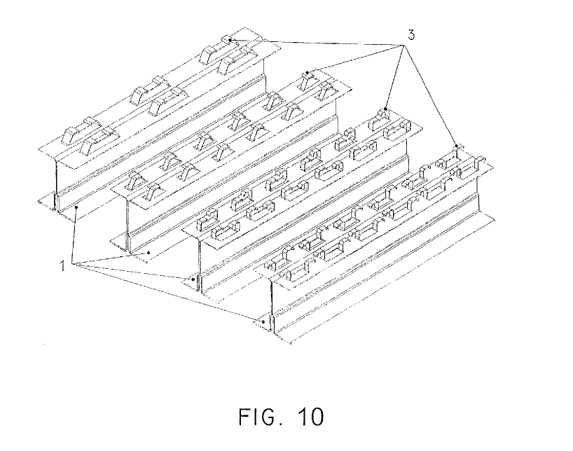

### DETAILED DESCRIPTION OF THE INVENTION

The object of the invention relates to a system for producing composite beams or joists of a floor structure for forming building structures or the like by means of using two materials, the first being a section (1) made of steel located in the lower portion of the composite beam, obtained by bending a steel sheet of little thickness which incorporates connectors (3) for the attachment: with the other material, and the second being an upper slab or board (2) attached to the previous section (1) through the connectors (3) thereof, produced using concrete, wood or resin fibreboards.

For the purpose of attaching the beams or joists of floor structures with other elements of the structural system of the building, such as metal beams (5) or metal supports (6), the sections (1) made of steel incorporate a longitudinal groove (4) in the lower portion and along the entire length for supporting and fitting the ends of said sections (1) in securing flat bars (7) which are attached to the metal beams (5) or metal supports (6) of the structural system of the building.

The system is therefore based on two key aspects of the design of sections (1) made of steel in addition to the fact that they adjust to the manner in which they are coupled to the other material. These aspects are:

Firstly: the design of the sections (1) made of steel includes the arrangement of a lower groove (4) allowing support and securing at the ends by means of means of attachment flat bars (7).

Secondly: the design of the section (1) includes the formation thereon of connectors (3) which are obtained by means of cutting, drawing and/or bending the sheet in the appropriate areas and serve to make the connection with the other material used.

The basic section (1) to be used in the system as well as several variants thereof is described below. In all cases, it may be necessary to attach some of the sheets which are next to one another in the section (1) such that they work together integrally. This is achieved by means of clinching these sheets in certain areas and at appropriate distances.

The basic section (1) to be used is an approximately symmetrical shape, although this is not an essential requirement, and is made up of a bent sheet which, starting from its edge located in the top right, has a horizontal sector (10) provided with connectors (3). This sector runs from its end towards the left and continues with another vertical sector (11) downwards with a transition curve or bevel between both. The vertical sector (11) has bends (12) with transition curves towards half or two thirds of its run, which allow moving its vertical axis slightly towards the right, then continuing with a transition curve and with another horizontal sector (13) towards the right, at the end of which, by means of a 180° bend, it changes direction and extends towards the left in another horizontal sector (14) parallel and tangent to the previous horizontal sector (13) to then turn 90° upwards such that it extends by means of another vertical sector (15) which is parallel and may be tangent to the lower portion of the vertical sector (11), reaching point (16) where the latter has bends (12) which move its vertical axis. From this point, where the axis of symmetry is located, the section (1) turns 180° with respect to its previous vertical sector (15), leaving a certain separation therewith, and again runs along the previous layout symmetrically and inversely.

A first variant of the basic section (1) to be used with concrete slabs (2) consists of incorporating a bend (17) in the first vertical sector (11) with a certain angle on the vertical, forming an inverted bottle neck in the upper portion of said vertical sector (11) which is filled with concrete and where it is possible to house an inner reinforcement (18) providing certain fire resistance of the assembly without the need for protecting the entire section (1).

A second variant of the basic section (1) consists of increasing the upper end edge to achieve several planes, where it is possible to locate connectors (3) when necessary given the high stresses to withstand. These planes are obtained by extending the edge of the upper end of the section (1) initially described and adding two upper sectors (19 and 20) with connectors (3). This addition to the basic section can also be in the symmetrical portion of the section. It is also possible to simplify the section (1) by not including any of the two new sectors (19 and 20) described.

A third variant of the basic section (1) consists of bending upwards, according to respective sectors (21 and 22), a portion of the two horizontal sectors (13 and 14) described thirdly and fourthly in the basic section (1) with a certain angle, between 30° and 90°, forming side channels (23) which can house installations or provide aesthetic effects in the section.

The connectors (3) which are incorporated in the previous sections (1) in the appropriate areas are formed in the steel sheet itself by means of cutting, drawing and bending, shaping said connectors (3).

These connectors (3) are of three basic types which do not exclude other possible types.

The first type of connectors (3) proposed is for connecting the metal section (1) with concrete slabs (2) and consists of making pairs of parallel cuts (24) in the steel sheet such that the strip comprised between both parallel cuts (24) is drawn upwards and is bent in the shape of trapezium (25). These connectors (3) is the shape of a trapezium (25) are complemented with steel reinforcements included within the concrete, in its horizontal plane and with 45° directions with respect to the axis of the section made of steel.

The second type of connectors (3) proposed is also for connecting the metal section (1) with concrete slabs (2) and consists of making three U-shaped cuts or five S-shaped cuts on the steel sheet generating one or two rectangles which are attached to the sheet at one of the short sides and which, once cut, are bent with several bends in three sectors which are starting from the section (1), a sector (26) with a certain angle (between 45° and 135°) towards the inside of the concrete, then a sector (27) in the horizontal direction on either side, and finally a sector (28) towards the section (1) creating a securing projection with an angle similar to that of the first sector (26). This gives rise to variants, some of which are depicted in the drawings.

The possibility of including ribs or bulkings (32) in certain areas of the metal section (1), made in the sheet vertically and regularly distributed along the upper portion of the vertical sectors (11) of the section (1), is proposed to improve the adherence and the combined work between the steel and the concrete.

The third type of connectors proposed is for connecting the metal section (1) with wooden boards or resin fibreboards (2) and consists of making four cuts on the sheet creating a strip (29) with central spike, or five S-shaped cuts creating two strips (30) with a side spike, such that they are all attached to the sheet at one of the short sides and the other end finishes in a spike. These strips (29 and 30) are bent perpendicularly to the section (1) made of steel, such that they form connectors which can be nailed into the wooden board or fibreboard (2) directly or by means of previously making notches in said board. In the event that said connectors formed by the strips (29 or 30) are longer than the board (2) is thick, the protruding portion of such connectors is bent once both materials are assembled.

The possibility of establishing an assembly formed by two metal sections (1) and one concrete slab, wooden board or fibreboard (2) on the edges of which continuous sheet parts (33) are arranged along the edge of the slab or board (2) is proposed in all cases. These sheet parts (33) have a slanted projection (34) in the central area for being attached to other slabs or boards (2) which also have edge sheet parts (33) which fit with those of the previous slab or board (2) with a certain clearance for allowing placement, to then rigidize the attachment by means of a part (35) having a rectangular section which is snap fitted between the two sheet parts (33).

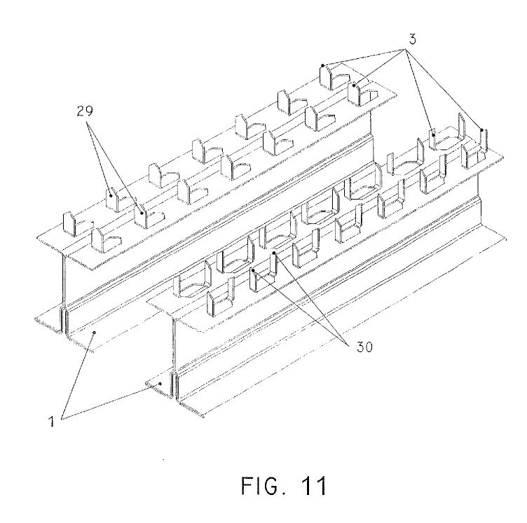

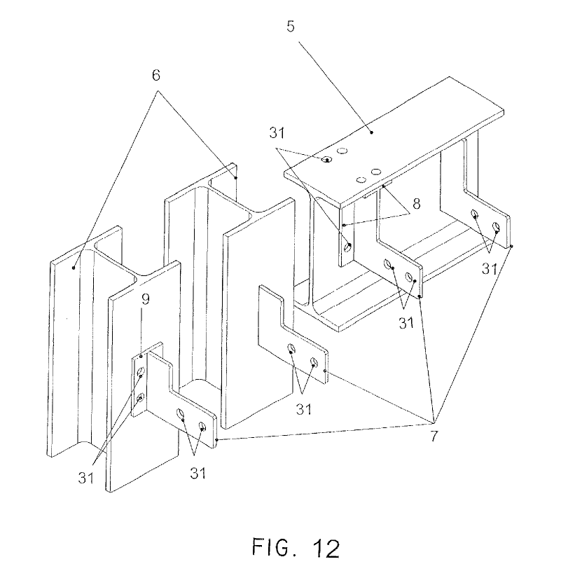

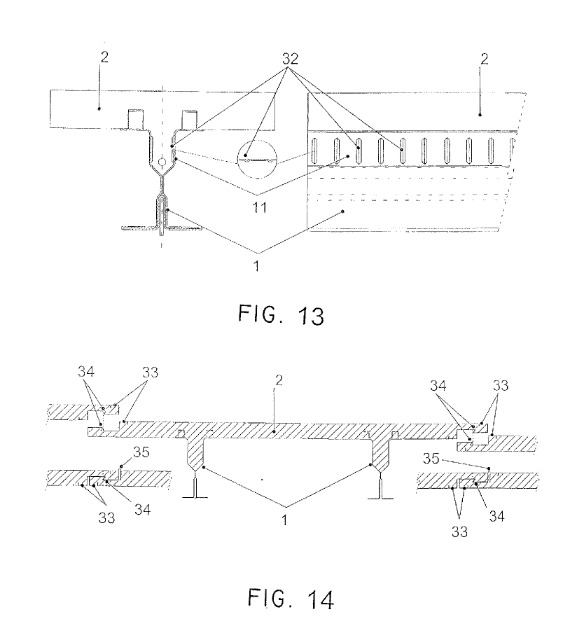

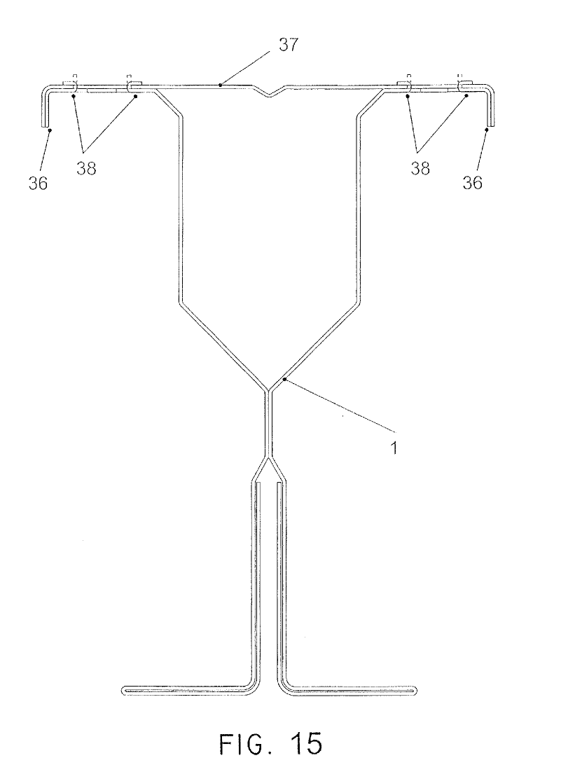

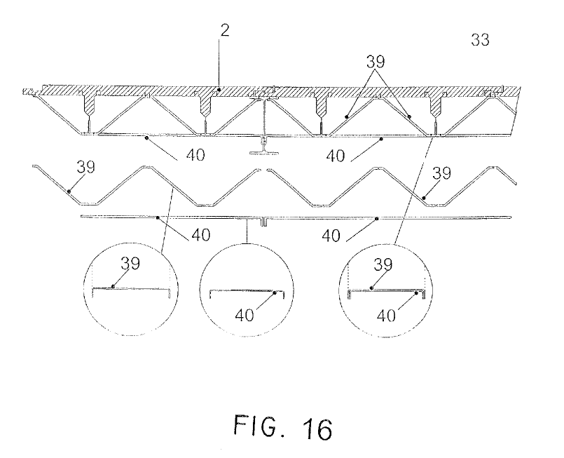

The possibility of replacing the wooden board or resin fibreboard with a C-shaped section made of steel sheet (37) placed horizontally and with the edges of the flanges downwards, the section (1) made of steel sheet having a downwards bend (36) at the end of the horizontal sectors (10) fitting with the corresponding flange of the C-shaped section (37) is also proposed. The attachment of both sections (1 and 37) to one another is performed, on each side of the C-shaped section (37), by means of a double row of connectors (38), as seen in FIG. 11, said connectors (38) being able to be placed in the longitudinal direction of the sections or be turned 90° about the axis,

In order to transversally rigidize the on site attachment of several concrete slabs, wooden boards or resin fibreboards (2) with the corresponding metal sections (1), transversally placing two C-shaped sections (39 and 40) in the lower portion, which are placed horizontally and with the edges of the flanges downwards such that one of these C-shaped sections (39) follows a layout of slanted bars going from the lower portion of the metal sections (1) to the intermediate lower area of the slabs or boards (2), being attached thereto through holes (31) by means of screws or nails, is also proposed. The other C-shaped section (40) follows a horizontal layout and at its lower portion is fitted to and attached through holes (31) by means of screws or nails to the previous C-shaped section (39) at the meeting points with the lower portion of the metal sections (1).

The attachment flat bars (7) for attachment to other structural elements of the building, such as metal beams (5) or metal supports (6), basically consist of vertical flat bars which are secured to the metal beams (5) or metal supports (6) and which are fitted inside the groove (4) which the metal section (1) has in its lower portion. Once supported on said flat bars (7), the metal section (1) is secured thereto by means of one or more screws assuring the transmission of stresses between said metal section (1) and the corresponding metal beam (5) or metal support (6).

These flat bars (7) can be directly welded to the core of the metal beam (5) or to the metal support (6), where appropriate. They can also be attached to said elements by means of other flat bars (8) placed perpendicularly to the flat bars (7) supporting the metal section (1) and which are attached to the metal beam (5) or metal support (6) by means of a screwed attachment. When attached to a metal support (6), a single vertical flat bar (9) where the screws are placed is sufficient. When attached to the core and to the upper flange of a metal beam (5), a vertical flat has attached to the core by means of screws and a horizontal flat bar (8) attached to the upper flange of the metal beam (5) also by means of screws is necessary.

### Embodiment of the Invention

In order to carry put the present invention it is necessary to manufacture a series of open sections (1) which incorporate in the design and production the necessary connectors (3) so that said section (1) can efficiently collaborate with the compression head of the other material (concrete, wood or fibres), such that the assembly comprises a composite beam where both materials contribute to the strength.

Cutting, rolling, bending or shaping techniques can be used to produce these sections (1). The bending or shaping is performed on steel sheet coils of little thickness, which are previously provided with the necessary connectors (3) by means of cutting and bending procedures and are later shaped by means of rollers having special shapes maintaining the connectors (3), or it is bent also maintaining the system of connectors (3) included in the section (1).

Another process which may be necessary is clinching in some areas of the section (1) made of steel for achieving the attachment of two sheets which are next to each other, such that the necessary rigidity is obtained.

1-14. (canceled)

15. A system for producing composite beams and floor structures of buildings comprising bent sections made of steel and another material attached by means of connectors formed in the section made of steel to form a composite beam with a slab or board placed on a section, which slab or board can be made of concrete, wood or resin fibres, wherein the section made of steel sheet contains, formed thereon in certain areas and located regularly along its longitudinal axis, connectors for the attachment to the slab or board made of the other material, said connectors being made up of strips of sheet of the section itself, separated therefrom and orientated in parallel or with small angles with respect to the longitudinal axis of the section, said strips of sheet being attached to the section made of steel at one or at both ends and are separated from the face plane of the section where they are located by means of cutting, drawing and bending so that such strips are integrated within the slab or board made of the other material and can transmit the necessary stresses between both materials.

16. The system of claim 15, wherein the section made of steel sheet has along its entire length a configuration with a lower groove for allowing the fitting, support and attachment by means of screws at the ends of the section to other metal beams or metal supports of the structure of the building by means of attachment parts having an L-shaped flat bar on which the ends of the section are supported and attached.

17. The system of claim 15, wherein the section made of steel sheet has a configuration which is made up of a sheet bent by means of transition curves which, starting at the end edge located in the top right, has a horizontal sector provided with connectors, said horizontal sector running from the right end towards the left and continuing downwards with another vertical sector by means of a transition curve or bevel, said vertical sector having bends with transition curves between half and two thirds of its run which allow moving the vertical axis slightly towards the right, the sheet then continues by means of a transition curve with another horizontal sector towards the right, at the end of which, by means of a 180° bend, the sheet changes direction and extends towards the left in another horizontal sector parallel and tangent to the previous horizontal sector, then the sheet turns 90° upwards such that it extends by means of a transition curve to another vertical sector which is parallel and can be tangent to or be separated a certain distance from the lower portion of the vertical sector, the sheet continues until the height of the bends, reaching point, from which point, where the axis of symmetry is located, the sheet continues by means of a 180° turn and a transition curve with respect to its previous vertical sector, leaving a certain separation with said vertical sector and the sheet again runs along the entire previous layout symmetrically and inversely.

18. The system of claim 15, wherein there is incorporated in the section made of steel sheet in its vertical sector a bend with a certain angle on the vertical axis (between approximately 45° and 30°) forming an inverted bottle neck in the upper portion of said vertical sector which is filled with concrete when this is the material of the upper slab or board and where it is possible to house an inner passive reinforcement for providing certain fire resistance of the assembly without the need for protecting the entire metal section.

19. The system of claim 15, wherein there are incorporated in the section made of steel sheet from the upper end edge of its horizontal sector two sectors for achieving a greater number of planes for locating connectors when necessary given the high stresses to withstand, said sectors being obtained by extending the edge of the upper end of the horizontal sector of the section by means of a transition curve with the sector which may or may not have connectors and which is bent upwards between approximately 30° and 90°, and then extends with a transition curve towards the right in the sector with connectors, this addition to the basic section also being added in the symmetrical portion of said section, it being also possible to simplify the section by not including any of the new sectors described.

20. The system of claim 15, wherein a modification is introduced in the section made of steel sheet which consists of bending part of the horizontal sectors and upwards, thus generating two new sectors forming an angle with the horizontal sectors and between approximately 30° and 135°, which allows obtaining side channels where installations can be housed or aesthetic effects can be provided in the section made of steel.

21. The system of claim 15, wherein the connectors proposed for connecting the section made of steel with concrete slabs are produced by means of making pairs of parallel cuts in the steel sheet, such that the strip comprised between both parallel cuts is drawn upwards and is bent in the shape of a trapezium, said connectors in the shape of a trapezium being complemented with steel reinforcements included within the concrete slab in its horizontal plane and with 45° directions with respect to the axis of the section made of steel.

22. The system of claim 15, wherein the connectors proposed for connecting the section made of steel with concrete slabs are produced by means of making three continuous U-shaped cuts or five continuous S-shaped cuts on the steel sheet of the section such that they generate one or two rectangles which are attached to the section at one of the short sides, respectively, said rectangles being bent with three bends in three sections which are, starting from the section, a sector bent with a certain angle with respect to the section comprised between 45° and 135°, then another sector which is bent in the horizontal direction parallel to the section in either direction and finally a sector which is bent towards the section, said sector creating a securing projection with an angle similar to that of the first sector, said sectors being complemented with steel reinforcements included within the concrete slab in its horizontal plane and with 45° directions with respect to the axis of the section made of steel.

23. The system of claim 15, wherein the connectors proposed for connecting the section made of steel with wooden boards or resin fibreboards are produced by means of making four or five continuous cuts in the steel sheet of the section such that they generate one or two strips of sheet, respectively, finished with a central spike or a side spike, respectively, which are attached to the section on the side opposite the spike, said strips being bent perpendicularly to the section and generating connectors, such that the assembly thereof can be nailed to the wooden board or fibreboard directly or by means of previously making notches in said board and in the event that the connectors formed by the are longer than the board is thick, the protruding portion of said connectors is bent once both materials are assembled.

24. The system of claim 15, wherein there are included attachment flat bars for attachment to other structural elements of the building such as metal beams or metal supports which are basically made up of vertical flat bars which are secured to such metal beams or metal supports and which are fitted during the assembly of the structure at the ends of the section made of steel inside the groove which the latter has in its lower portion, and, once the section made of steel is supported on said flat bars, the section made of steel is secured thereto by means of one or more screws assuring the transmission of stresses between said section and the corresponding metal beam or metal support, said flat bars being able to be welded directly to the metal beam or to the metal support and also being able to be attached to the metal beam by means of other flat bars bent at an angle and perpendicularly attached in the central portion to the respective flat bar by means of welding on the two sides which are in contact, said fiat bars being attached to the core and to the upper flange of the metal beam by means of screws through holes, said flat bars being able to be attached to the metal supports by means of other rectangular flat bars perpendicularly attached in the central portion to the respective flat bar by means of welding on the side in contact, said flat bars being attached to the core or to the flanges of the metal support by means of screws through holes.

25. The system of claim 15, wherein ribs which are placed vertically and regularly distributed along the vertical sector of the section are included in the vertical sector of the section.

26. The system of claim 15, wherein the assembly formed by one or several metal sections and a concrete slab, wooden board or resin fibreboard has continuous sheet parts on the edges of the slab or board along the entire edge and have a slanted projection in the central area for fitting the edge part of one slab or board with that of the other slab or board with a certain clearance during placement, the attachment then being rigidized by means of placing a part having a rectangular section which is snap fitted between the two sheet parts.

27. The system of claim 15, wherein the wooden board or resin fibreboard is replaced with a C-shaped section made of steel sheet placed horizontally and with the edges of the flanges downwards, and in that the section made of steel sheet has a downwards bend at the end of the horizontal sector fitting with the flange of the C-shaped section, the attachment of both sections to one another being performed, on each side of the C-shaped section, by means of a double row of connectors placed in the longitudinal direction of the sections or turned 90° about the axis.

28. The system of claim 15, wherein the assembly formed by several concrete slabs, wooden boards or resin fibreboards with the corresponding metal sections is rigidized transverse thereto by means of two C-shaped sections placed horizontally and with the edges of the flanges downwards, such that one of these C-shaped sections follows a layout of slanted bars going from the lower portion of the metal sections to the intermediate lower area of the slabs or boards, being attached thereto by means of screws or nails, the other C-shaped section following a horizontal layout and at its lower portion being fitted with and attached by means of screws or nails to the C-shaped section at the meeting points with the lower portion of the metal sections.
